(19) United States
(12) Patent Application Publication
(10) Pub. No.: US 2007/0204299 A1
(43) Pub. Date: Aug. 30, 2007

(54) Integrated Media Content

(75) Inventor: Shannon B. Vosseller, San Francisco, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/276,458

(22) Filed: Feb. 28, 2006

(51) Int. Cl. H04N 7/10; H04N 7/025; H04N 7/16; H04N 5/445

(52) U.S. Cl. 725/46; 725/135; 725/34; 725/35

(57) ABSTRACT

Integrated media content is described. In an embodiment, scheduled programs metadata is received that describes scheduled programs which are available for viewing when the scheduled programs are delivered from a content provider according to a programming schedule. The scheduled programs metadata can be compared to on-demand programs metadata that describes on-demand programs which are available for viewing upon request, and a determination can be made that a scheduled program corresponds to an on-demand program such that either program can be substituted for the other when selected for viewing.

### BACKGROUND

While television viewing includes scheduled programs delivered for viewing according to a programming schedule, such as conventional television broadcasts, television viewing is increasingly on-demand. The use of digital video recorders (DVRs) and other video on-demand playback systems are shifting viewing habits from having to watch broadcast programs at programming times scheduled by a provider of the programs to being able to watch pre-recorded and/or on-demand programs at a time convenient for a viewer. Television-based client devices, such as a DVR, can be implemented to receive and record media content in the form of programs, on-demand videos, movies, and any other type of broadcast and/or interactive television-based entertainment and information.

With the variety of programming and media content sources, a viewer often has to first determine from where a program of interest may be located. A viewer has to keep track of where digital video recordings can be accessed, from where on-demand programs can be requested, and transitioning between these and a programming guide that lists regularly scheduled programs.

### SUMMARY

This summary is provided to introduce simplified concepts of integrated media content which is further described below in the Detailed Description. This summary is not intended to identify essential features of the claimed subject matter, nor is it intended for use in determining the scope of the claimed subject matter.

In an embodiment of integrated media content, scheduled programs metadata is received that describes scheduled programs which are available for viewing when the scheduled programs are delivered from a content provider according to a programming schedule. Scheduled programs can include broadcast programs having a scheduled air time, on-demand programs having dates or terms for their availability, scheduled DVR recordings, or lists of programs with yet to be determined availability. The scheduled programs metadata can be compared to on-demand programs metadata that describes on-demand programs which are available for viewing upon request, and a determination can be made that a scheduled program corresponds to an on-demand program such that either program can be substituted for the other when selected for viewing, recording, included in search results, or provided as a recommendation. Additionally, the on-demand programs metadata can be compared to recorded program metadata that describes a recorded program which has been recorded for viewing, and a determination can be made that the recorded program corresponds to the on-demand program such that either program can be substituted for the other when selected for viewing, recording, included in search results, or provided as a recommendation.

In another embodiment of integrated media content, a viewer-selectable input of a selected program can be received where the selected program is made available for viewing as a scheduled program when delivered from a content provider according to a programming schedule. A determination can be made that the scheduled program is available as an on-demand program which is available for viewing upon request, and an integrated media content list indicates that the selected program can be selected for viewing as the on-demand program. The integrated media content list can include program listings corresponding to any combination of scheduled programs, recorded programs, and on-demand programs, where any or all of the programs are available from different content sources.

The viewer-selectable input of the selected program can be received to initiate a recording of the scheduled program when delivered from the content provider according to the programming schedule. A recording conflict can be determined if the initiated recording of the scheduled program conflicts with a previously scheduled recording. The recording conflict can be resolved by canceling the initiated recording of the scheduled program and initiating delivery of the on-demand program when the recording of the scheduled program is requested for viewing. The on-demand version of the program can also be recorded with a DVR system as a substitute for the broadcast capture of the on-demand program.

Additionally, a storage conflict can be determined if a recording media does not have capacity to record the scheduled program. The storage conflict can be resolved by canceling the initiated recording of the scheduled program, and initiating delivery of the on-demand program when the recording of the scheduled program is requested for viewing. Alternatively, or in addition, the storage conflict can be resolved by determining that a previously recorded program corresponds to an additional on-demand program, erasing the previously recorded program from the recording media such that the recording media has capacity to record the scheduled program, and initiating delivery of the additional on-demand program when the previously recorded program is requested for viewing.

### BRIEF DESCRIPTION OF THE DRAWINGS

The same numbers are used throughout the drawings to reference like features and components:

FIG. 1 illustrates an exemplary television-based system in which embodiments of integrated media content can be implemented.

FIG. 2 illustrates an exemplary integrated media content list.

FIG. 3 illustrates exemplary method(s) for integrated media content.

FIG. 4 illustrates other exemplary method(s) for integrated media content.

FIG. 5 illustrates other exemplary method(s) for integrated media content.

FIG. 6 illustrates an exemplary IP-based television (IPTV) system in which embodiments of integrated media content can be implemented.

FIG. 7 illustrates various components of an exemplary client device in which embodiments of integrated media content can be implemented.

FIG. 8 illustrates various devices and components in an exemplary entertainment and information system in which embodiments of integrated media content can be implemented.

### DETAILED DESCRIPTION

Integrated media content is described in which embodiments provide an integrated media content list that can include program listings corresponding to any combination of scheduled programs, recorded programs, and on-demand programs, where any or all of the programs may be available from different content sources. A viewer can select any of the programs for viewing from the unified list of available media content which can be provided by way of different delivery mechanisms and from the different content sources. The integrated media content list provides that a viewer does not have to keep track of where content and other digital video recordings are maintained, from where on-demand programs can be requested, whether upcoming programs will be available for viewing, or transitioning between any of these and regularly scheduled programming.

Additionally, the metadata of scheduled programs, recorded programs, and/or on-demand programs can be compared to determine if any two programs correspond to each to other such that either program can be substituted for the other when selected for viewing or capturing (e.g., recording, storing, maintaining, and the like). For example, a viewer may select a scheduled program to watch and be disappointed that the program has already started. The integrated media content list can indicate to the viewer that the selected program is also available for viewing on-demand, in which case the viewer can select to watch the program from the beginning without being dependent upon the time-based programming schedule of the scheduled program.

Integrated media content also provides that recording conflicts can be resolved, such as when two programs are scheduled to be recorded at the same time, or overlapping times. For example, a viewer may select a scheduled program from a program guide to be recorded when the program is delivered for viewing. If the recording of the scheduled program conflicts with a previously scheduled recording of a different program, an on-demand program or other recorded program may be located that corresponds to the scheduled program selected to be recorded. If a corresponding on-demand program is located for example, then the recording of the scheduled program can be canceled and the on-demand program can be delivered when the viewer selects the program for viewing.

Additionally, storage capacity conflicts can be resolved, such as when a program is selected to be recorded but the recording media of a television-based client device, server-based content storage, and/or other storage device is full, or does not have the capacity remaining to record the selected program. For example, a viewer may select a scheduled program from a program guide to be recorded when the program is delivered for viewing. If the recording media does not have capacity to record the scheduled program, an on-demand program or other recorded program may be located that corresponds to the scheduled program selected to be recorded, or that corresponds to a previously recorded program maintained on the recording media.

If an on-demand program corresponding to the scheduled program selected to be recorded is located for example, then the recording of the scheduled program can be canceled and the on-demand program can be delivered for viewing when the viewer selects the program for viewing. Alternatively, if an on-demand program corresponding to the previously recorded program is located for example, then the previously recorded program can be erased from the recording media to allow the recording of the scheduled program, and the on-demand program can be delivered when the viewer selects the previously recorded program for viewing.

While aspects of the described systems and methods for integrated media content can be implemented in any number of different computing systems, environments, television-based entertainment systems, and/or configurations, embodiments of integrated media content are described in the context of the following exemplary system architecture(s).

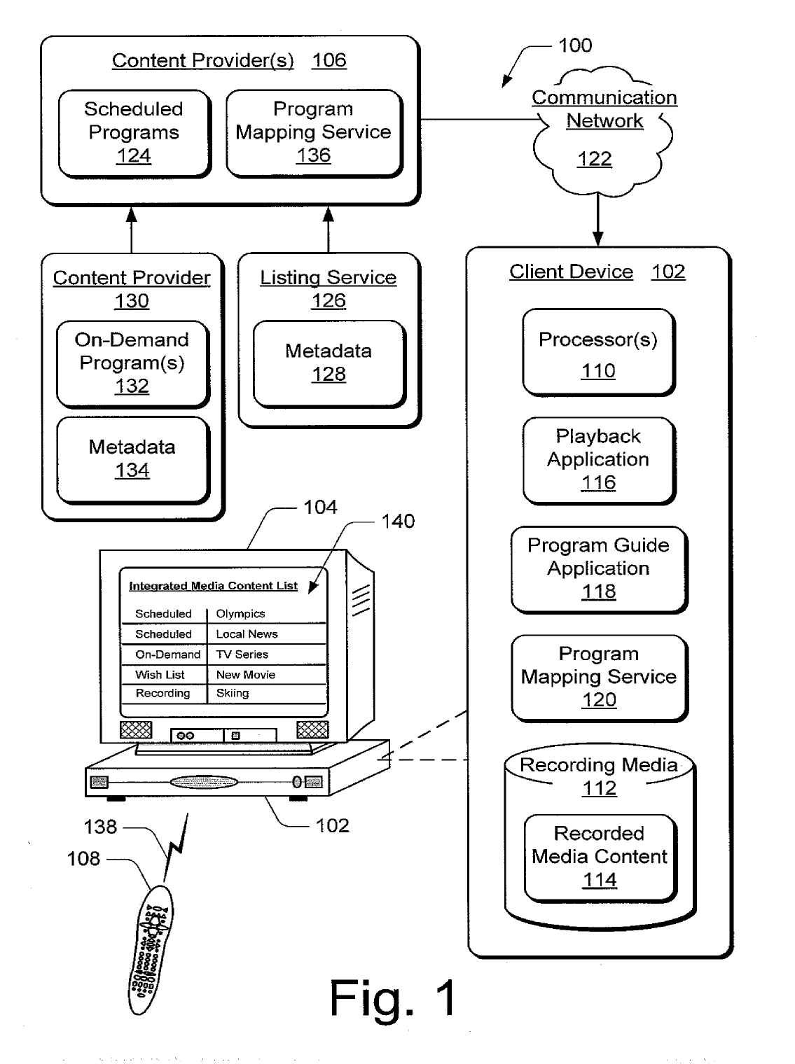

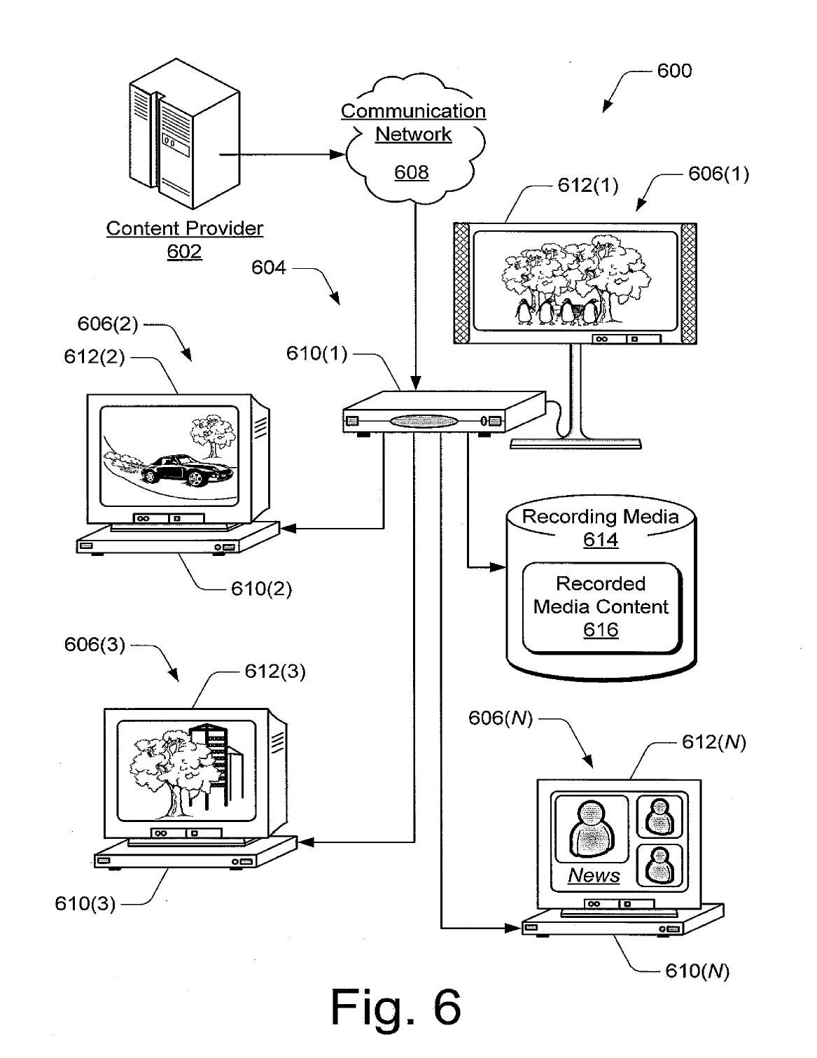

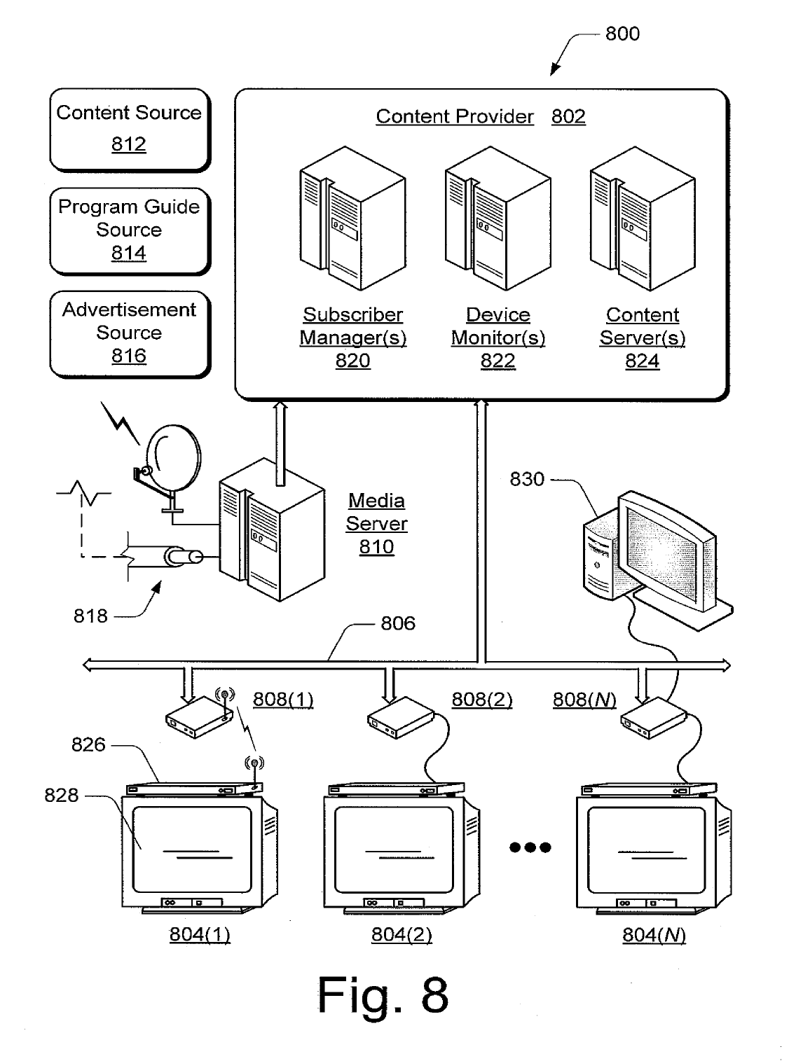

FIG. 1 illustrates an exemplary television-based system 100 in which embodiments of integrated media content can be implemented. The system 100 includes a television-based client device 102, a display device 104, content provider(s) 106, and a remote control device 108. The display device 104 can be any type of television, monitor, or similar television-based display system that renders audio, video, and/or image data. The client device 102 and display device 104 together are but one example of a television-based client system, examples of which are described with reference to the exemplary IP-based television (IPTV) system 600 shown in FIG. 6, and with reference to the exemplary entertainment and information system 800 shown in FIG. 8.

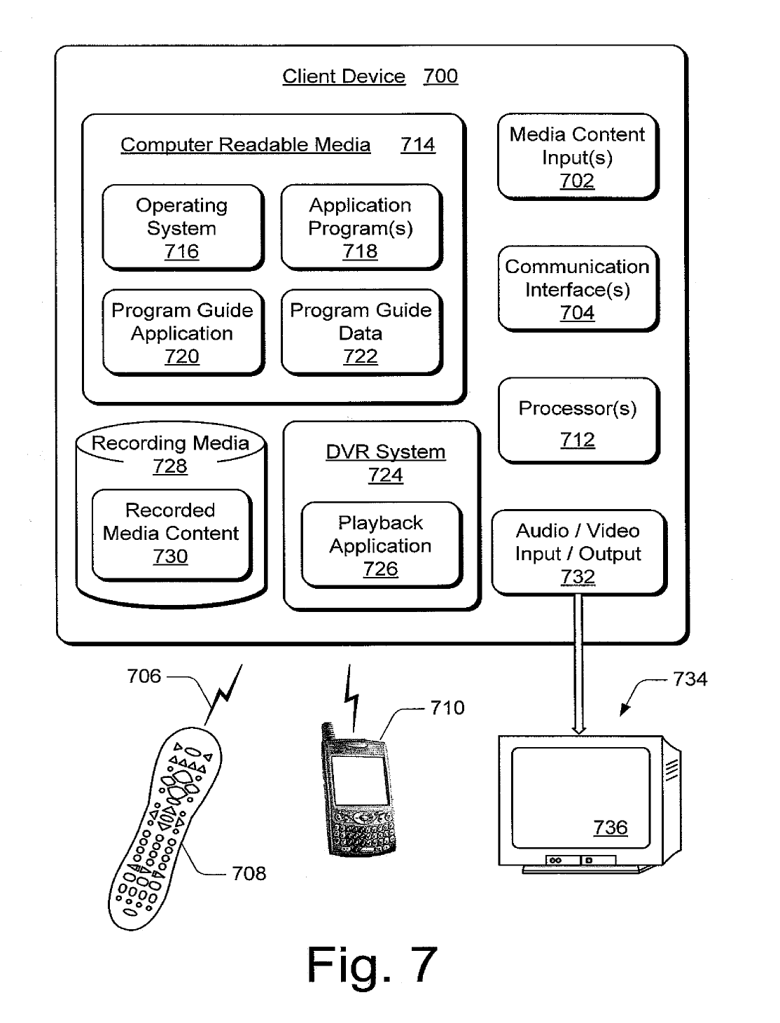

Client device 102 can be implemented in any number of embodiments, such as a set-top box, a digital video recorder (DVR) and playback system, an appliance device, a gaming device, and as any other type of client device that may be implemented in a television-based entertainment and information system. In this example, client device 102 includes one or more processor(s) 110 and a recording media 112 that maintains recorded media content 114. The client device 102 also includes a playback application 116, a program guide application 118, and a program mapping service 120, each of which can be implemented as computer executable instructions and executed by the processor(s) 110 to implement embodiments of integrated media content. Additionally, client device 102 may be implemented with any number and combination of differing components as further described below with reference to the exemplary client device 700 shown in FIG. 7.

Recording media 112, along with playback application 116, can be implemented as a DVR system to record and maintain the recorded media content 114 which may be any form of on-demand and/or broadcast media content such as programs, movies, commercials, music, and similar audio, video, and/or image content that client device 102 receives and/or records. Further, client device 102 may access or receive additional recorded media content that is maintained with a remote data store, such as from a video-on-demand server, or media content that is maintained at a broadcast center or content provider that distributes the media content to subscriber sites and client devices.

The television-based client device 102 is configured for communication with the content provider(s) 106 via a communication network 122, which in this example, is an IP-based network. A content provider 106 delivers scheduled programs 124 to the client device 102 for viewing. The scheduled programs 124 are delivered for viewing according to a time-based programming schedule. A listing service 126 can provide metadata 128 to the content provider 106. In an embodiment, a broadcaster can be both a content provider 106 and/or a listing service 126. The metadata 128 describes the scheduled programs 124, and can be obtained from any number of providers and compiled to include any form of information that describes and/or characterizes a scheduled program, such as a program identifier, program title, plot description, actor information, a date of production, broadcast channel, television network, artistic information, music compilations, and any other possible descriptive information about the program. The content provider 106 can also receive and deliver the metadata 128 to the client device 102 along with the scheduled programs 124. Further, the metadata 128 can be delivered in-band or out-of-band, and/or can be computed from video, watermarks, closed captioning, and/or from any other features of aspects of media content.

An additional content provider 130 can provide on-demand programs 132 to the content provider 106 which receives and/or delivers an on-demand program to the client device 102 when the on-demand program is requested by a viewer. The additional content provider 130 can also provide metadata 134 that describes the on-demand programs 132. The client device 102 can receive program content (such as scheduled programs, on-demand programs, and the like), various forms of media content, program guide data, advertising content, and any other possible media content from content server(s) of the content provider(s) 106 via the IP-based network 122. For example, client device 102 can receive a scheduled program as media content which is recorded and stored as the recorded media content 114.

The program mapping service 120 at client device 102 (or at a server device, and/or both) can compare the metadata associated with different program types to determine corresponding programs. For example, the program mapping service 120 can compare scheduled program metadata 128 to on-demand program metadata 134 to determine that a scheduled program corresponds to and is available as an on-demand program. Similarly, the program mapping service 120 can compare metadata associated with a recorded program 114 to on-demand program metadata 134 to determine that the recorded program corresponds to and is available as an on-demand program. The metadata associated with a recorded program 114 is one example of the scheduled program metadata 128 if the program was recorded from a broadcast of a scheduled program 124.

In one embodiment, a scheduled program identifier contained within the scheduled program metadata 128 can be compared to an on-demand program identifier contained within the on-demand program metadata 134 to determine corresponding programs. Alternatively, or in addition, other metadata comparison basis can be a URL code, a universal identifier, a registered identifier, closed-caption data, signal processing, finger printing identifier, any heuristic or rules-based comparison, and/or any other form of metadata comparison basis.

The program mapping service 120 can also enhance the metadata associated with the different program types upon determining corresponding programs. For example, if the program mapping service 120 determines that a scheduled or recorded program corresponds to an on-demand program, the program mapping service 120 can enhance scheduled program metadata with on-demand program metadata if the on-demand program metadata provides more detail about the corresponding programs. Similarly, the program mapping service 120 can enhance the on-demand program metadata with the scheduled program metadata if the scheduled program metadata provides more detail about the corresponding programs. For example, the metadata associated with a scheduled program may include more descriptive parental rating information because the scheduled program is broadcast for viewing, whereas an on-demand version of the program may not include the parental rating information because on-demand does not have the viewing limitations of the broadcast program.

The content provider 106 can optionally include a program mapping service 136 to implement embodiments of integrated media content as described with reference to the program mapping service 120 at client device 102. Although the program mapping service 136 at content provider 106 and the program mapping service 120 at client device 102 are illustrated and described as single application programs, each of the program mapping services 120, 136 can be implemented as several component applications distributed to each perform one or more functions in a television-based system. Further, although the program mapping service 120 at client device 102 and the program mapping service 136 at content provider 106 are illustrated and described as separate application programs, the program mapping services 120, 136 can be implemented to function together to implement embodiments of integrated media content.

The playback application 116 at client device 102 is a video control application that, in this example, can be implemented to control the playback of media content, such as the recorded media content 114, the scheduled programs 124 and the on-demand programs 132, and/or other video on-demand media content, recorded content, music, and any other audio, video, and/or image media content which can be rendered and/or displayed for viewing on the display device 104. The playback application 116 and/or the program guide application 118 is implemented to receive user-selectable content navigation input commands 138, such as from the remote control device 108 which includes various configuration and television-specific input keys, an input keypad, and various user-selectable input controls to navigate a program guide, an integrated media content list, and other programming selections.

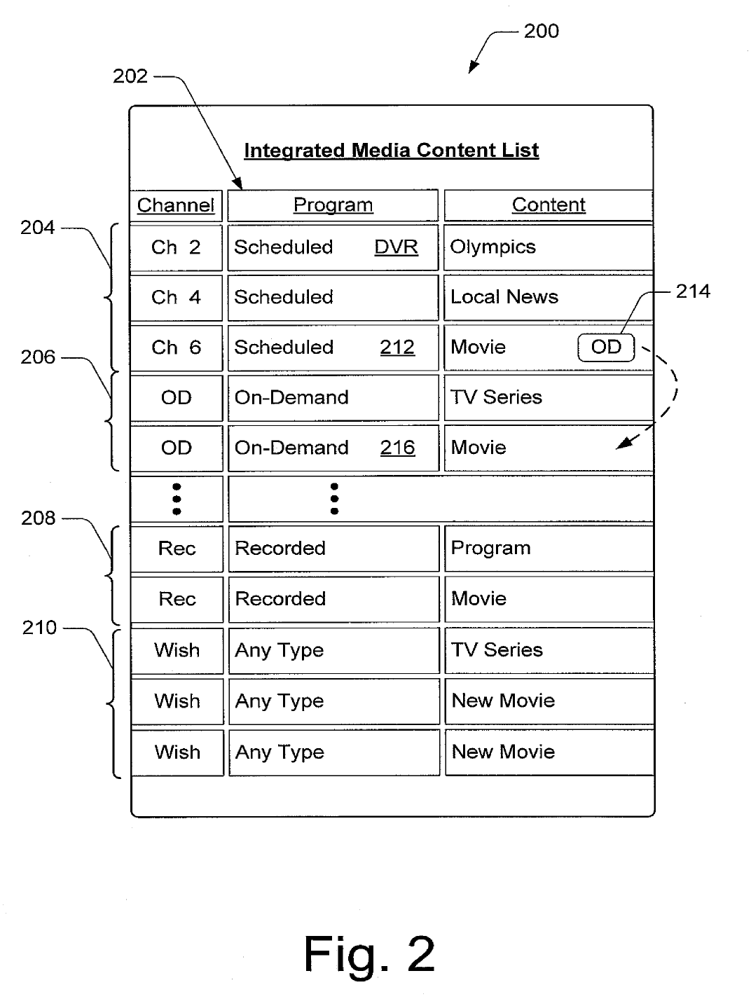

The program guide application 118 at client device 102 (or at a server device, and/or both) can be implemented to process program guide data and generate program guides for display which enable a viewer to navigate through an onscreen display and locate scheduled programs, recorded programs, on-demand programs and movies, interactive game selections, network-based applications, and other media access information or content of interest to the viewer. In this example, the program guide application 118 can also generate an integrated media content list 140 for display on the display device 104. The integrated media content list 140 can include program listings corresponding to any combination of scheduled programs, recorded programs, and on-demand programs. Additionally, the integrated media content list 140 can list program(s) which will become available as any one of a scheduled program, on-demand program, or recorded program. For example, a viewer can create a “wish list” of programs that are not yet available, or that will be at a future time. An exemplary integrated media content list 200 is described below with reference to FIG. 2.

Embodiments of integrated media content provide for recording conflict resolution and storage conflict resolution. When a viewer-selectable input 138 is received to initiate a recording of a scheduled program 124 delivered from content provider 106, a recording conflict may result if the initiated recording of the scheduled program conflicts with a previously scheduled recording, and/or a storage conflict may result if the recording media 112 does not have capacity to record the scheduled program. The recording conflict and the storage conflict can both be resolved by canceling the initiated recording of the scheduled program and delivering an on-demand program that corresponds to the requested scheduled program when requested for viewing. Alternatively, the storage conflict can also be resolved by determining that a previously recorded program corresponds to an on-demand program, erasing the previously recorded program from the recording media 112 to provide the recording capacity, and delivering the on-demand program that corresponds to the previously recorded program when the program is requested for viewing.

FIG. 2 illustrates an exemplary integrated media content list 200 that includes various examples of different media content types that are selectable for viewing from the unified list. The integrated media content list 200 includes program listings 202 corresponding to any combination of scheduled programs 204, on-demand programs 206, and recorded programs 208. The scheduled programs 204 also include DVR recording requests as shown with reference to “channel 2” in the program listings 202. A scheduled program can also include upcoming or requested program that is added to a wish list, auto-recorded, or an upcoming one-time recording or series recording. Additionally, the integrated media content list 200 includes programs 210 which will become available as any one of a scheduled program, on-demand program, or recorded program. For example, a viewer can create a “wish list” of programs that are not yet available, or that will be at a future time. A viewer can create a content wish list and record, purchase, or be reminded of programs when they become available. The “wish list” programs can be made available in advance, or can be made available as on-demand programming for a fee. The integrated media content list 200 is merely exemplary and can include any number and combination of additional display features and options.

A viewer can select any of the programs 202 for viewing from the unified list 200 of available media content which can be provided by way of different delivery mechanisms and from different content providers. The integrated media content list 200 provides that a viewer does not have to keep track of where digital video recordings are maintained, from where on-demand programs can be requested, whether upcoming programs will be available for viewing, or transitioning between any of these and regularly scheduled programming.

Additionally, any two programs that have been determined to be corresponding can be substituted for each other when selected for viewing. For example, a viewer may select a scheduled program 212 to watch and be disappointed that the program has already started. The integrated media content list 200 can include an indicator 214 to the viewer that the scheduled program 212 is also available for viewing on-demand 216, in which case the viewer can select to watch the on-demand program 216 from the beginning without being dependent upon the time-based programming schedule of the scheduled program.

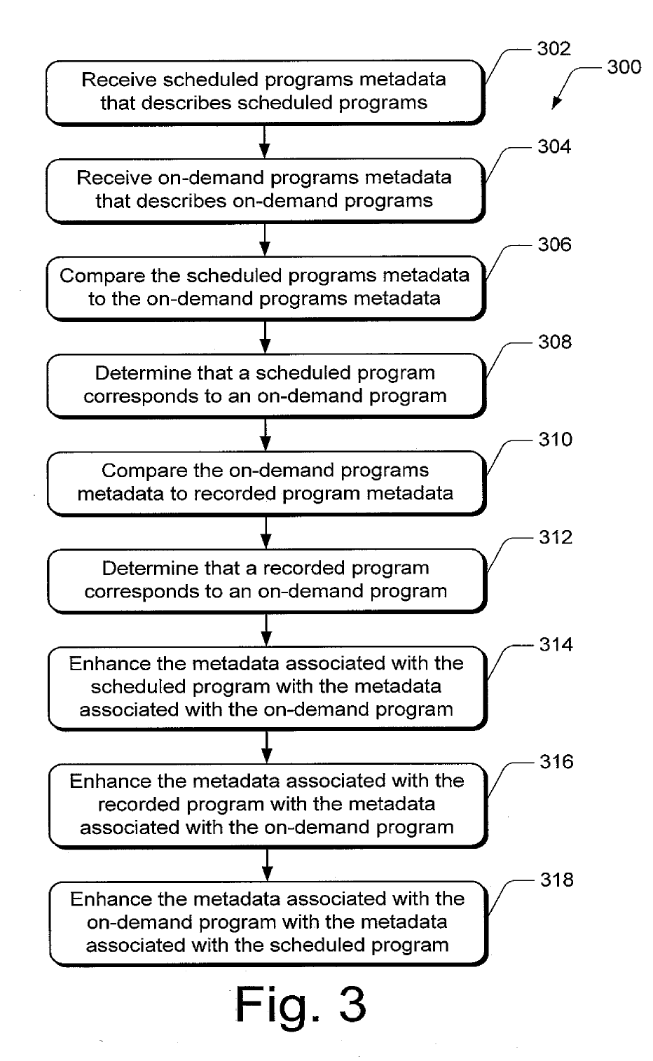

Methods for integrated media content, such as exemplary methods 300, 400, and 500 described with reference to respective FIGS. 3, 4, and 5, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 3 illustrates an exemplary method 300 for integrated media content and is described with reference to the television-based system 100 shown in FIG. 1 and the exemplary integrated media content list 200 shown in FIG. 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 302, scheduled programs metadata is received that describes scheduled programs which are available for viewing when the scheduled programs are delivered from a content provider according to a programming schedule. For example, metadata 128 associated with scheduled programs 124 is delivered by content provider 106 to client device 102. At block 304, on-demand programs metadata is received that describes on-demand programs which are available for viewing upon request. For example, metadata 134 associated with on-demand programs 132 is delivered by content provider 106 to client device 102.

At block 306, the scheduled programs metadata is compared to the on-demand programs metadata. For example, the program mapping service 120 at client device 102 (and/or optionally the program mapping service 136 at content provider 106) compares the scheduled programs metadata 128 to the on-demand programs metadata 134. This can include comparing a scheduled program identifier in the scheduled programs metadata 128 to an on-demand program identifier in the on-demand programs metadata 134 to determine that a scheduled program corresponds to an on-demand program. At block 308, a determination is made that a scheduled program corresponds to an on-demand program such that either program can be substituted for the other when selected for viewing. For example, scheduled program 212 corresponds to on-demand program 216 as indicated by the indicator 214 in the integrated media content list 200.

At block 310, the on-demand programs metadata is compared to recorded program metadata that describes a recorded program which has been recorded for viewing. For example, the program mapping service 120 at client device 102 (and/or optionally the program mapping service 136 at content provider 106) compares the on-demand programs metadata 134 to recorded programs metadata (e.g., metadata 128 if a scheduled program is recorded). At block 312, a determination is made that a recorded program corresponds to an on-demand program such that either program can be substituted for the other when selected for viewing.

At block 314, the metadata associated with the scheduled program is enhanced with the metadata associated with the on-demand program if the metadata associated with the on-demand program provides more detail about the corresponding programs. Similarly, at block 316, the metadata associated with the recorded program is enhanced with the metadata associated with the on-demand program if the metadata associated with the on-demand program provides more detail about the corresponding programs. Alternatively, at block 318, the metadata associated with the on-demand program is enhanced with the metadata associated with the scheduled or recorded program if the metadata associated with the scheduled or recorded program provides more detail about the corresponding programs.

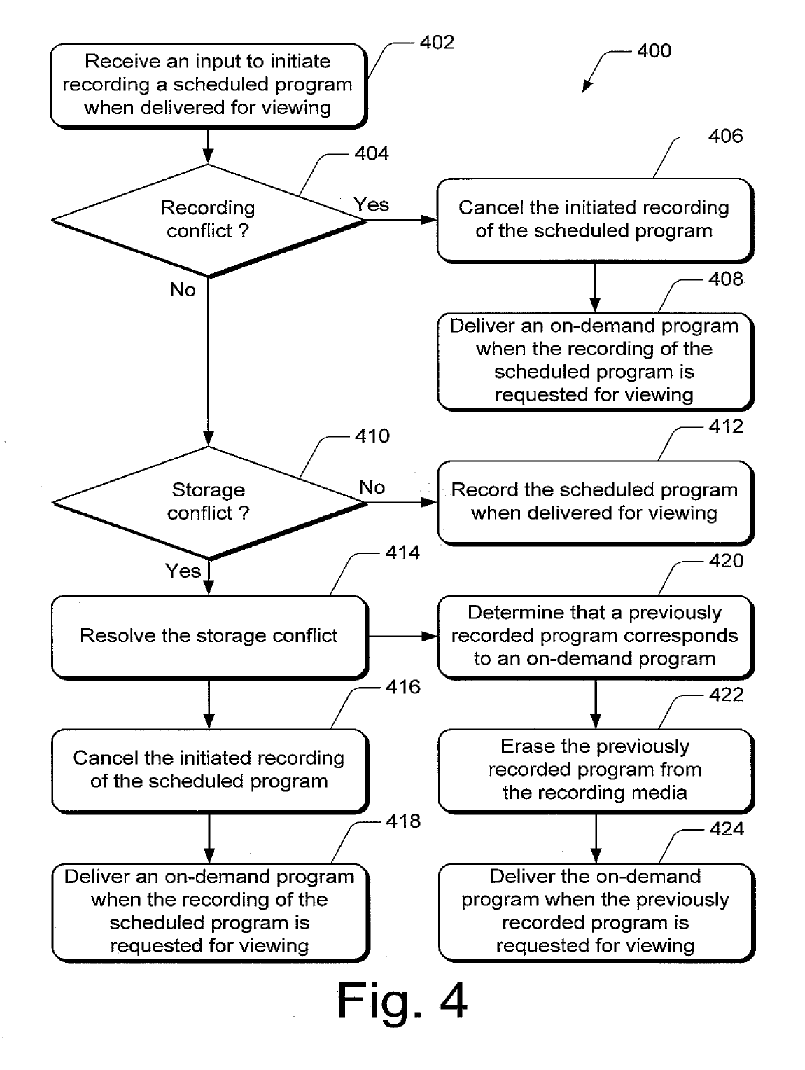

FIG. 4 illustrates an exemplary method 400 for integrated media content and is described with reference to the television-based system 100 shown in FIG. 1 and the exemplary integrated media content list 200 shown in FIG. 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 402, an input is received to initiate a recording of a scheduled program when the scheduled program is delivered for viewing. For example, a viewer-selectable input 138 can be received via the remote control device 108 to record a scheduled program 124 when the content provider 106 delivers the scheduled program 124 for viewing according to a time-based programming schedule.

At block 404, a determination is made as to whether the initiated recording of the scheduled program conflicts with a previously scheduled recording. If there is a recording conflict (i.e., “yes” from block 404), then the recording conflict is resolved. At block 406, the initiated recording of the scheduled program is canceled, and at block 408, an on-demand program corresponding to the scheduled program is delivered when the recording of the scheduled program is requested for viewing.

If there is not a recording conflict (i.e., “no” from block 404), then a determination is made as to whether a recording media does not have capacity to record the scheduled program at block 410. If there is not a storage conflict (i.e., “no” from block 410), then the scheduled program is recorded at block 412 when the program is delivered for viewing according to the programming schedule. If there is a storage conflict (i.e., “yes” from block 410), then the storage conflict is resolved at block 414 one of two ways.

At block 416 (in a first embodiment), the initiated recording of the scheduled program is canceled and, at block 418, an on-demand program that corresponds to the scheduled program is delivered when the recording of the scheduled program is requested for viewing.

At block 420 (in a second embodiment), a determination is made that a previously recorded program corresponds to an on-demand program. At block 422, the previously recorded program is erased from the recording media such that the recording media has capacity to record the scheduled program. At block 424, the additional on-demand program is delivered when the previously recorded program is requested for viewing.

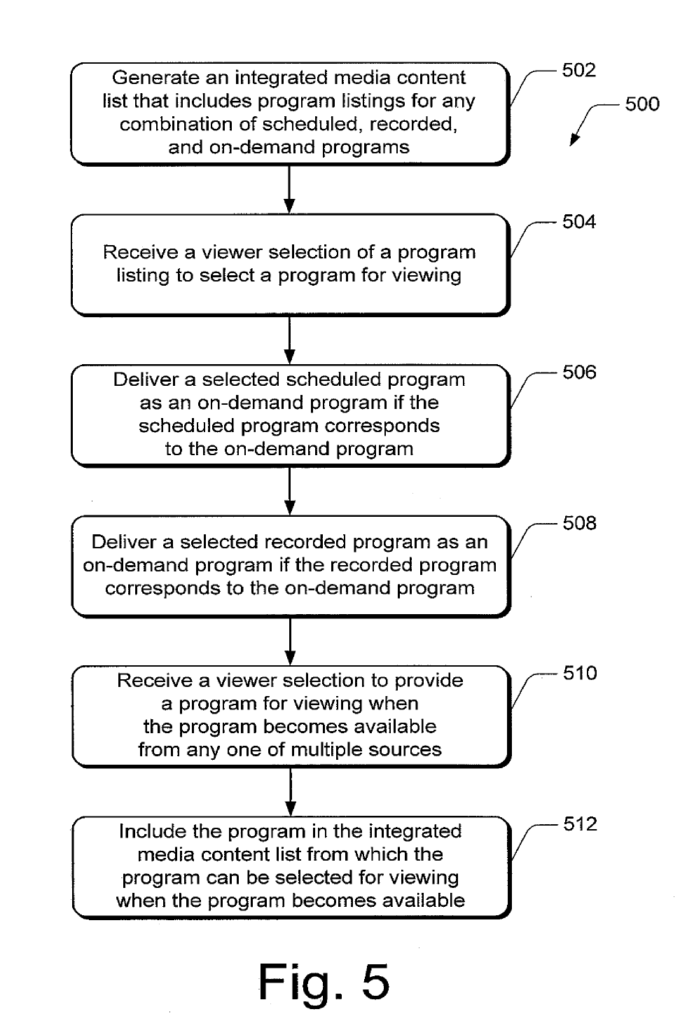

FIG. 5 illustrates an exemplary method 500 for integrated media content and is described with reference to the television-based system 100 shown in FIG. 1 and the exemplary integrated media content list 200 shown in FIG. 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 502, an integrated media content list is generated that includes program listings for any combination of scheduled programs, recorded programs, and on-demand programs. For example, integrated media content list 200 includes program listings 202 for any combination of scheduled programs 204, on-demand programs 206, recorded programs 208, and “wish list” programs 210. At least two of the programs in the integrated media content list 200 are delivered for viewing from different sources. For example, a scheduled program 124 is available from a first content source, or content provider 106. An on-demand program 132 can be available directly from content provider 130, or via content provider 106. A recorded program 114 can be available from recording media 112 at the client device 102, or from a network-based recording media.

At block 504, a viewer selection of a program listing is received to select a program for viewing. At block 506, a selected scheduled program is delivered as an on-demand program upon determining that the scheduled program corresponds to the on-demand program. For example, the program mapping service 120 at client device 102 can determine that a scheduled program corresponds to an on-demand program by comparing metadata associated with each of the respective programs. Similarly, at block 508, a selected recorded program is delivered as an on-demand program upon determining that the recorded program corresponds to the on-demand program.

At block 510, a viewer selection is received to provide a program for viewing when the program becomes available from any one of multiple sources. For example, the integrated media content list 200 includes programs 210 in a “wish list” of programs that will become available as any one of a scheduled program, on-demand program, or recorded program at a future time. At block 512, the program is included in the integrated media content list from which the program can be selected for viewing when the program becomes available as any one of a scheduled program, recorded program, or an on-demand program

FIG. 6 illustrates an exemplary IP-based television (IPTV) environment 600 in which embodiments of integrated media content can be implemented. The IPTV environment 600 includes a content provider 602 and a viewing system 604 that can include any number of television-based client systems 606. A client system 606(1) is configured for communication with the content provider 602 via a communication network 608 which, in this example, is an IP-based network. In addition to the client system 606(1), the viewing system 604 includes television-based client systems 606(2-N), and can represent a household viewing system that has several viewing areas, such as different rooms, for viewing television programming.

Television-based programs may include any form of programs, scheduled programs, commercials, music, movies, video on-demand movies and other media content, recorded media content, interactive games, network-based applications, and any other similar audio, video, and/or image content. In addition, programming in general may include music streamed from a computing device to a client device, such as a television-based set-top box, and may also include video on-demand media content delivered from a server, a photo slideshow, and any other audio, video, and/or image content received from any type of media content source.

The television-based client systems 606(1-N) may be implemented with any number and combination of differing components as further described below with reference to the exemplary client device 700 shown in FIG. 7. Further, the IPTV environment 600 may be implemented with any number and combination of differing components as described below with reference to the exemplary entertainment and information system 800 shown in FIG. 8.

The television-based client system 606(1) includes a client device 610(1) and a display device 612(1), such as any type of television, monitor, or similar television-based display system that renders audio, video, and/or image data. Similarly, the television-based client systems 606(2-N) each include a respective client device 610(2-N) and a respective display device 612(2-N). Each client device 610 can be implemented in any number of embodiments, such as a television-based set-top box, a digital video recorder (DVR) and playback system, an appliance device, a gaming system, and as any other type of client device that may be implemented in a television-based entertainment and information system.

Client device 610(1) receives program content from content provider 602 via the communication network 608. In the example viewing system 604, client device 610(1) is a master client device that receives one or more data streams from content provider 602 and then arbitrates stream allocation to distribute the data streams, one each, to one or more of the other satellite client devices 610(2-N). The satellite client devices 610(2-N) connect to the master client device 610(1) to receive a data stream for live television, delayed program viewing, and/or recorded DVR playback. The data streams are allocated by the content provider 602 to the viewing system 604 (e.g., a household), and the data streams can be any combination of high definition and/or standard definition television data streams. For example, the viewing system 604 may receive one high definition data stream and three standard definition data streams depending upon available bandwidth to deliver the data streams.

Although the data streams are not shown specifically, the arrowed communication links illustrate various data communication links which include the data streams. Additionally, the arrowed communication links are not intended to be interpreted as a one-way communication link from client device 610(1) to client device 610(2), for example. It is contemplated that any one or more of the arrowed communication links can facilitate two-way data communication, such as from client device 610(2) to client device 610(1) for example, and from client device 610(1) to content provider 602.

In this system, the master client device 610(1) receives four (4) data streams from the content provider 602 via the communication network 608. A viewing selection from a first data stream is shown for viewing on display device 612(1) at the television-based client system 606(1). A second data stream is directed from the master client device 610(1) to the television-based client system 606(2) and a viewing selection from a second data stream is shown for viewing on display device 612(2). Similarly, a third data stream is directed from the master client device 610(1) to the television-based client system 606(3) and a viewing selection from the third data stream is shown for viewing on display device 612(3). Additionally, a fourth data stream is directed from the master client device 610(1) to the television-based client system 606(4) and a viewing selection from the fourth data stream is shown for viewing on display device 612(4).

The viewing system 604 also includes recording media 614 which can be implemented as a DVR system to record and maintain media content 616, such as any form of programs, movies, and similar audio, video, and/or image content that may be distributed or otherwise received from content provider 602. In one embodiment, the recording media can be implemented as an independent component of the viewing system 604 and connected to the master client device 610(1). Alternatively, the recording media 614 can be implemented as a component of the master client device 610(1) which manages recordings initiated from any of the other satellite client devices 610(2-N). In yet another embodiment, the recording media 614 may be a distributed recording system where any one or more of the client devices 610(1-N) include recording media that is centrally managed by the master client device 610(1).

FIG. 7 illustrates various components of an exemplary client device 700 which can be implemented as any form of a computing, electronic, and/or television-based client device, and in which embodiments of integrated media content can be implemented. For example, the client device 700 can be implemented as the television-based client device 102 shown in FIG. 1 and/or as any one of the television-based client devices 610(1-N) shown in FIG. 6 as part of the viewing system 604.

Client device 700 includes one or more media content inputs 702 which may include Internet Protocol (IP) inputs over which streams of media content are received via an IP-based network. Device 700 further includes communication interface(s) 704 which can be implemented as any one or more of a serial and/or parallel interface, a wireless interface, any type of network interface, a modem, and as any other type of communication interface. A wireless interface enables client device 700 to receive control input commands 706 and other information from an input device, such as from remote control device 708, portable computing-based device (such as a cellular phone) 710, or from another infrared (IR), 802.11, Bluetooth, or similar RF input device.

A network interface provides a connection between the client device 700 and a communication network by which other electronic and computing devices can communicate data with device 700. Similarly, a serial and/or parallel interface provides for data communication directly between client device 700 and the other electronic or computing devices. A modem facilitates client device 700 communication with other electronic and computing devices via a conventional telephone line, a DSL connection, cable, and/or other type of connection.

Client device 700 also includes one or more processors 712 (e.g., any of microprocessors, controllers, and the like) which process various computer executable instructions to control the operation of device 700, to communicate with other electronic and computing devices, and to implement embodiments of integrated media content. Client device 700 can be implemented with computer readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 714 provides data storage mechanisms to store various information and/or data such as software applications and any other types of information and data related to operational aspects of client device 700. For example, an operating system 716 and/or other application programs 718 can be maintained as software applications with the computer readable media 714 and executed on processor(s) 712 to implement embodiments of integrated media content.

For example, client device 700 can be implemented to include a program guide application 720 that is implemented to process program guide data 722 and generate program guides for display which enable a viewer to navigate through an onscreen display and locate broadcast scheduled programs, recorded programs, video on-demand programs and movies, interactive game selections, network-based applications, and other media access information or content of interest to the viewer. The application programs 718 can include a program mapping service 120, 136 to implement features and embodiments of integrated media content as described herein. Alternatively, a programmed application can be implemented as an integrated module or component of the program guide application 720 to implement embodiments of integrated media content. The client device 700 can also include a DVR system 724 with playback application 726, and recording media 728 to maintain recorded media content 730.

The client device 700 also includes an audio and/or video output 732 that provides audio and video to an audio rendering and/or display system 734, or to other devices that process, display, and/or otherwise render audio, video, and image data. Video signals and audio signals can be communicated from device 700 to a television 736 (or to other types of display devices) via an RF (radio frequency) link, S-video link, composite video link, component video link, analog audio connection, or other similar communication link.

FIG. 8 illustrates an exemplary entertainment and information system 800 in which an IP-based television environment can be implemented, and in which embodiments of integrated media content can be implemented. System 800 facilitates the distribution of program content, program guide data, and advertising content to multiple viewers and to multiple viewing systems. System 800 includes a content provider 802 and television-based client systems 804(1-N) each configured for communication via an IP-based network 806. Each television-based client system 804(1-N) is an example of the television-based client system 606(1) described with reference to FIG. 6. Each of the television-based client systems 804(1-N) can receive one or more data streams from content provider 802 and then arbitrate stream allocation to distribute the data streams, one each, to one or more other satellite client devices in a viewing system.

The network 806 can be implemented as a wide area network (e.g., the Internet), an intranet, a Digital Subscriber Line (DSL) network infrastructure, or as a point-to-point coupling infrastructure. Additionally, network 806 can be implemented using any type of network topology and any network communication protocol, and can be represented or otherwise implemented as a combination of two or more networks. A digital network can include various hardwired and/or wireless links 808(1-N), routers, gateways, and so on to facilitate communication between content provider 802 and the client systems 804(1-N). The television-based client systems 804(1-N) receive program content, program guide data, advertising content, closed captions data, and the like from content server(s) of the content provider 802 via the IP-based network 806.

System 800 includes a media server 810 that receives program content from a content source 812, program guide data from a program guide source 814, and advertising content from an advertisement source 816. In an embodiment, the media server 810 represents an acquisition server that receives the audio and video program content from content source 812, an EPG server that receives the program guide data from program guide source 814, and/or an advertising management server that receives the advertising content from the advertisement source 816.

The content source 812, the program guide source 814, and the advertisement source 816 control distribution of the program content, the program guide data, and the advertising content to the media server 810 and/or to other television-based servers. The program content, program guide data, and advertising content is distributed via various transmission media 818, such as satellite transmission, radio frequency transmission, cable transmission, and/or via any number of other wired or wireless transmission media. In this example, media server 810 is shown as an independent component of system 800 that communicates the program content, program guide data, and advertising content to content provider 802. In an alternate implementation, media server 810 can be implemented as a component of content provider 802.

Content provider 802 is representative of a headend service in a television-based content distribution system, for example, that provides the program content, program guide data, and advertising content to multiple subscribers (e.g., the television-based client systems 804(1-N)). The content provider 802 can be implemented as a satellite operator, a network television operator, a cable operator, and the like to control distribution of program and advertising content, such as movies, television programs, commercials, music, and other audio, video, and/or image content to the client systems 804(1-N).

Content provider 802 includes various components to facilitate media data processing and content distribution, such as a subscriber manager 820, a device monitor 822, and a content server 824. The subscriber manager 820 manages subscriber data, and the device monitor 822 monitors the client systems 804(1-N) (e.g., and the subscribers), and maintains monitored client state information.

Although the various managers, servers, and monitors of content provider 802 (to include the media server 810 in one embodiment) are illustrated and described as distributed, independent components of content provider 802, any one or more of the managers, servers, and monitors can be implemented together as a multi-functional component of content provider 802. Additionally, any one or more of the managers, servers, and monitors described with reference to system 800 can implement features and embodiments of integrated media content.

The television-based client systems 804(1-N) can be implemented to include a client device 826 and a display device 828 (e.g., a television). A client device 826 of a television-based client system 804 can be implemented in any number of embodiments, such as a set-top box, a digital video recorder (DVR) and playback system, an appliance device, a gaming system, and as any other type of client device that may be implemented in a television-based entertainment and information system. In an alternate embodiment, client system 804(N) is implemented with a computing device 830 as well as a client device 826. Additionally, any of the client devices 826 of a client system 804 can implement features and embodiments of integrated media content as described herein.

Although embodiments of integrated media content have been described in language specific to structural features and/or methods, it is to be understood that the subject of the appended claims is not necessarily limited to the specific features or methods described. Rather, the specific features and methods are disclosed as exemplary implementations of integrated media content.

1. A method, comprising:
receiving scheduled programs metadata that describes scheduled programs which are available for viewing when the scheduled programs are delivered from a content provider according to a programming schedule;
comparing the scheduled programs metadata to on-demand programs metadata that describes on-demand programs which are available for viewing upon request; and
determining that a scheduled program corresponds to an on-demand program such that either program can be substituted for the other when selected for viewing.

2. A method as recited in claim 1, wherein comparing includes comparing a scheduled program identifier in the scheduled programs metadata to an on-demand program identifier in the on-demand programs metadata to determine that the scheduled program corresponds to the on-demand program.

3. A method as recited in claim 1, further comprising:
comparing the on-demand programs metadata to recorded program metadata that describes a recorded program which has been recorded for viewing; and
determining that the recorded program corresponds to the on-demand program such that either program can be substituted for the other when selected for viewing.

4. A method as recited in claim 3, further comprising generating an integrated media content list for display from which a program can be selected for viewing, the program being any one of the scheduled program, the recorded program, or the on-demand program.

5. A method as recited in claim 1, further comprising:
receiving an input to initiate a recording of a selected program when the selected program is delivered for viewing as the scheduled program; and
generating an integrated media content list for display from which the selected program can be selected for viewing as the on-demand program upon determining that the scheduled program corresponds to the on-demand program.

6. A method as recited in claim 1, further comprising:
receiving a viewer selection to provide a program for viewing when the program becomes available from any one of multiple sources; and
generating an integrated media content list for display from which the program can be selected for viewing when the program becomes available, the program being any one of the scheduled program, a recorded program, or the on-demand program.

7. A method as recited in claim 1, further comprising:
receiving an input to initiate a recording of the scheduled program when the scheduled program is delivered for viewing;
determining a recording conflict if the initiated recording of the scheduled program conflicts with a previously scheduled recording; and
resolving the recording conflict by canceling the initiated recording of the scheduled program and delivering the on-demand program when the recording of the scheduled program is requested for viewing.

8. A method as recited in claim 1, further comprising:
receiving an input to initiate a recording of the scheduled program when the scheduled program is delivered for viewing;
determining a storage conflict if a recording media does not have capacity to record the scheduled program; and
resolving the storage conflict by canceling the initiated recording of the scheduled program and delivering the on-demand program when the recording of the scheduled program is requested for viewing.

9. A method as recited in claim 1, further comprising:
receiving an input to initiate a recording of the scheduled program when the scheduled program is delivered for viewing;
determining a storage conflict if a recording media does not have capacity to record the scheduled program;
resolving the storage conflict by:
determining that a previously recorded program corresponds to an additional on-demand program;
erasing the previously recorded program from the recording media such that the recording media has capacity to record the scheduled program; and
delivering the additional on-demand program when the previously recorded program is requested for viewing.

10. A method as recited in claim 1, further comprising at least one of:
enhancing the metadata associated with the scheduled program with the metadata associated with the on-demand program if the metadata associated with the on-demand program provides more detail about the corresponding programs; or
enhancing the metadata associated with the on-demand program with the metadata associated with the scheduled program if the metadata associated with the scheduled program provides more detail about the corresponding programs.

11. A television-based device, comprising:
a program guide application configured to receive a viewer-selectable input of a selected program that is made available for viewing as a scheduled program when delivered from a content provider according to a programming schedule;
a program mapping service configured to determine that the scheduled program is available as an on-demand program which is available for viewing upon request; and
an integrated media content list configured to indicate that the selected program can be selected for viewing as the on-demand program.

12. A television-based device as recited in claim 11, wherein the integrated media content list includes program listings corresponding to any combination of scheduled programs, recorded programs, and on-demand programs, and wherein at least two of the programs are delivered for viewing from different sources.

13. A television-based device as recited in claim 11, wherein the program mapping service is further configured to compare scheduled program metadata to on-demand program metadata to determine that the scheduled program corresponds to the on-demand program.

14. A television-based device as recited in claim 11, wherein the program mapping service is further configured to compare a scheduled program identifier to an on-demand program identifier to determine that the scheduled program corresponds to the on-demand program.

15. A television-based device as recited in claim 11, wherein the program mapping service is further configured to at least one of:
enhance scheduled program metadata with on-demand program metadata if the on-demand program metadata provides more detail about the corresponding programs; or
enhance the on-demand program metadata with the scheduled program metadata if the scheduled program metadata provides more detail about the corresponding programs.

16. A television-based device as recited in claim 11, wherein the program guide application is further configured to:
receive the viewer-selectable input to initiate a recording of the scheduled program when delivered from the content provider according to the programming schedule;
determine a recording conflict if the initiated recording of the scheduled program conflicts with a previously scheduled recording; and
resolve the recording conflict by canceling the initiated recording of the scheduled program; and
initiate delivery of the on-demand program when the recording of the scheduled program is requested for viewing.

17. A television-based device as recited in claim 11, wherein the program guide application is further configured to:
receive the viewer-selectable input to initiate a recording of the scheduled program when delivered from the content provider according to the programming schedule;
determine a storage conflict if a recording media does not have capacity to record the scheduled program; and
resolve the storage conflict by canceling the initiated recording of the scheduled program; and
initiate delivery of the on-demand program when the recording of the scheduled program is requested for viewing.

18. A television-based device as recited in claim 11, wherein the program guide application is further configured to:
receive the viewer-selectable input to initiate a recording of the scheduled program when delivered from the content provider according to the programming schedule;
determine a storage conflict if a recording media does not have capacity to record the scheduled program;
resolve the storage conflict by:
determining that a previously recorded program corresponds to an additional on-demand program;
erasing the previously recorded program from the recording media such that the recording media has capacity to record the scheduled program; and
initiate delivery of the additional on-demand program when the previously recorded program is requested for viewing.

19. An integrated media content list, comprising:
a first program listing configured for viewer selection to initiate viewing a scheduled program delivered from a first content source according to a programming schedule;
a second program listing configured for viewer selection to initiate viewing an on-demand program delivered from a second content source; and
a third program listing configured for viewer selection to initiate viewing a recorded program maintained on recording media at a third content source.

20. An integrated media content list as recited in claim 19, further comprising a fourth program listing that identifies a program which will become available as any one of an additional scheduled program, an additional on-demand program, or as an additional recorded program.
